(19) United States
(12) Patent Application Publication
(10) Pub. No.: US 2025/0257592 A1
(43) Pub. Date: Aug. 14, 2025

(54) TRAILER DOOR STATUS DETECTION FROM TRACTOR

(71) Applicant: Outrider Technologies, Inc., Brighton, CO (US)

(72) Inventors: Andrew Smith, Brighton, CO (US); Luciano Spinello, Brighton, CO (US); Ira Renfrew, Brighton, CO (US)

(21) Appl. No.: 19/048,151

(22) Filed: Feb. 7, 2025

Related U.S. Application Data
(60) Provisional application No. 63/551,795, filed on Feb. 9, 2024.

(51) Int. Cl. E05B 81/70; G08B 21/18

(52) U.S. Cl. CPC E05B 81/70; G08B 21/18

(57) ABSTRACT

A door status monitor determines a status of a rear door of a trailer from a tractor. The door status monitor receives an input source including information of the trailer. The input source includes at least one of an image, a LIDAR point cloud, and a RADAR point cloud from at least one of a camera, a LIDAR, and a RADAR, respectively, mounted to the tractor and having a view that includes at least a rear of the trailer. A door status monitor processes the input source through a neural network trained to generate a trailer door status defining the status of the rear door of the trailer. A door status monitor outputs the trailer door status.

### RELATED APPLICATION

This application claim priority to U.S. Patent Application Ser. No. 63/551,795, titled “Trailer Door Status Detection from Tractor,” filed Feb. 9, 2024, and included herein by reference in its entirety.

### BACKGROUND

A rear door of a trailer presents a hazard when unlatched while the trailer is being maneuvered.

### SUMMARY

One aspect of the present embodiments includes the realization that prior to positioning a trailer to a loading dock, the rear doors of the trailer should already be latched open to allow access to the interior of the trailer from the loading dock. Often, it is important for the autonomous tractor to learn whether the rear doors of the trailer are latched open. For example, maneuvering the trailer when the rear doors are open but not latched causes the rear doors to swing wildly, potentially causing damage to the doors and/or other property (e.g., adjacent trailers or infrastructure). The present embodiments solve this problem by detecting the rear doors of a hitched trailer from the tractor prior to and during maneuvering of the trailer. Advantageously, the tractor autonomously detects the status of the rear doors without manual intervention prior to maneuvering the trailer within the yard. For example, when collecting the trailer from a staging area, the rear doors of the trailer should be already latched open. However, when the rear doors are not opened, or are not latched open correctly, time is often wasted resolving the problem at or near the loading dock. By detecting the status of the rear doors from the tractor, the tractor may stop maneuvering when the doors are not latched open but swinging, and may request assistance to latch the doors open when they are not latched open correctly. Advantageously, by detecting unlatched doors, the tractor improves safety during maneuvering of the trailer within the autonomous yard. Accordingly, the tractor may thereby prevent the trailer being positioned at a loading dock with the doors closed, which often requires additional maneuvering of the trailer clear of the loading dock and any adjacent trailers to allow the doors to be opened fully and latched and may prevent damage caused by swinging doors during maneuvering.

In certain embodiments, the techniques described herein relate to a method for determining a status of a rear door of a trailer from a tractor, including: receiving an input source including information of the trailer, the input source including at least one of an image, a LIDAR point cloud, and a RADAR point cloud from at least one of a camera, a LIDAR, and a RADAR, respectively, mounted to the tractor; processing the input source through a neural network using a trailer door trained model to generate a trailer door status defining the status of the rear door of the trailer; and outputting the trailer door status.

In certain embodiments, the techniques described herein relate to a method for determining a status of a rear door of a smart trailer from a tractor, including: receiving, by a controller of the tractor and from the smart trailer, a signal encoding trailer status information of the smart trailer; decoding, by the controller, the trailer status information to determine a status of a rear door of the smart trailer; and outputting, from the tractor, the trailer door status.

In certain embodiments, the techniques described herein relate to a door status monitor, including: a rigid body for attaching to a vehicle; at least one of a camera, a LIDAR, and a RADAR having fixed positional and orientational relationship by the rigid body; a neural network having a trailer door trained model that processes an input source including at least one of an image, a point cloud, and RADAR data captured by at least one of the camera, the LIDAR, and the RADAR to generate a trailer door status defining the status of a rear door of a trailer included in the input source; and outputting the trailer door status to an external device.

### BRIEF DESCRIPTION OF THE FIGURES

FIG. 1 is an aerial view showing one example autonomous yard that uses an autonomous tractor to move trailers between a staging area and loading docks of a warehouse, in embodiments.

FIG. 2 is a block diagram illustrating key functional components of the tractor of FIG. 1, in embodiments.

FIG. 3 is a schematic diagram showing the autonomous tractor of FIGS. 1 and 2 reversing the trailer up to a loading dock, in embodiments.

FIG. 4 is a block diagram illustrating the door status monitor of FIG. 2 in further example detail, in embodiments.

FIG. 5 is a schematic diagram illustrating example use of the camera, the LIDAR device, and/or the radar by the door status monitor of FIG. 4 to determine the trailer door status of the trailer being towed by the tractor, in embodiments.

FIG. 6 is a schematic diagram illustrating example use of the camera, the LIDAR device, and/or the radar by the door status monitor of FIG. 4 to determine the trailer door status of other trailers encountered within the autonomous yard, in embodiment.

FIG. 7 is a block diagram illustrating one example stand-alone door status monitor, in embodiments.

FIG. 8 is a flowchart illustrating one example method for determining a status of a rear door of a trailer from a tractor, in embodiments.

FIG. 9 is a block diagram illustrating the door status monitor of FIG. 2 in further example detail, in embodiments.

FIG. 10 is a schematic diagram illustrating example use of the camera 218(2) of FIG. 2 by the door status monitor of FIG. 9 to determine the trailer door status of a trailer being towed by the tractor that includes door-status indicators, in embodiments.

### DETAILED DESCRIPTION OF THE EMBODIMENTS

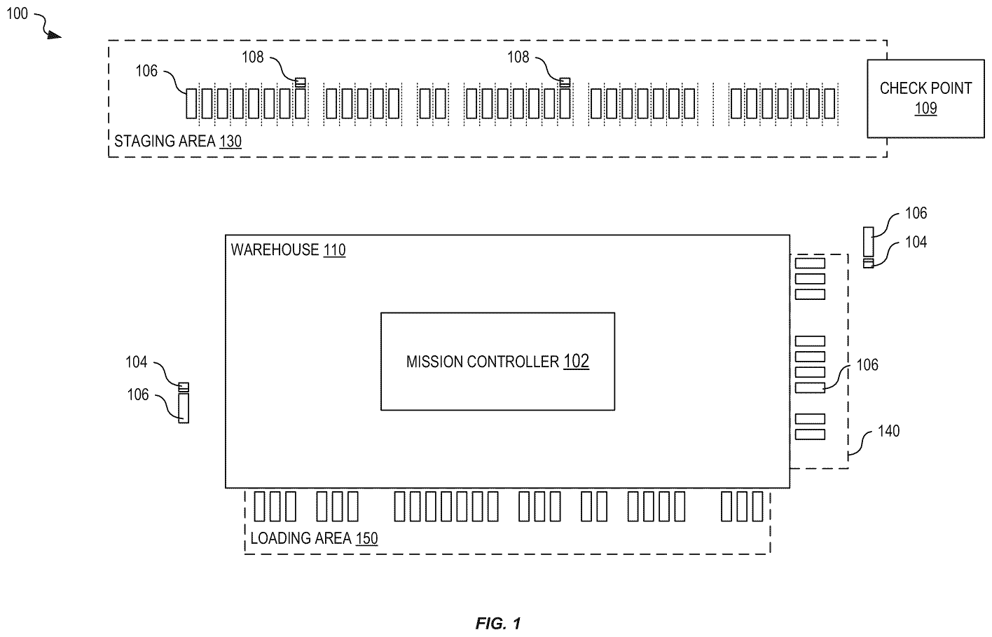

FIG. 1 is an aerial view showing one example autonomous yard 100 (e.g., a goods handling facility, shipping facility, etc.) that uses an autonomous tractor 104 to move trailers 106 between a staging area 130 and loading docks of a warehouse 110. The autonomous tractor 104 may be an electric vehicle, or may use a combustion-based engine such as a diesel tractor. For example, over-the-road (OTR) tractors 108 deliver goods-laden trailers 106 from remote locations and retrieve trailers 106 for return to such locations (or elsewhere—such as a storage depot). In a standard operational procedure, OTR tractor 108 arrives with trailer 106 and checks-in at a facility entrance checkpoint 109. A guard/attendant enters information (e.g., trailer number or QR (ID) code scan-embedded information already in the system, which would typically include: trailer make/model/year/service connection location, etc.) into a mission controller 102 (e.g., a computer software server that may be located offsite, in the cloud, fully onsite, or partially located within a facility building complex, shown as a warehouse 110). Warehouse 110 includes perimeter loading docks (located on one or more sides of the building), associated (typically elevated) cargo portals and doors, and floor storage, all arranged in a manner familiar to those of skill in shipping, logistics, and the like.

By way of a simplified operational example, after arrival of OTR tractor 108 and trailer 106, the guard/attendant at checkpoint 109 directs the driver to deliver trailer 106 to a specific numbered parking space in a designated staging area 130, which may include a large array of side-by-side trailer parking locations, arranged as appropriate for the facility's overall layout.

Once the driver has parked the trailer in the designated parking space of the staging area 130, he/she disconnects the service lines and ensures that connectors are in an accessible position (e.g., when adjustable/sealable), and decouples OTR tractor 108 from trailer 106. When trailer 106 is equipped with swing doors, this decoupling also provides an opportunity for the driver to unlatch and clip trailer doors in the open position, when directed (e.g., by yard personnel) to do so.

Later, (e.g., when warehouse 110 is ready to process the trailer) mission controller 102 directs (e.g., commands or otherwise controls) tractor 104 to automatically couple (e.g., hitch) with trailer 106 at an indicated pick-up spot in staging area 130 and move trailer 106 to a drop-off spot at an assigned unloading dock in unloading area 140 for example. Accordingly, tractor 104 couples with trailer 106 at the pick-up spot, moves trailer 106 to unloading area 140, and then backs trailer 106 into the assigned loading dock at the drop-off spot such that the rear of trailer 106 is positioned in close proximity with the portal and cargo doors of warehouse 110. The pick-up spot and drop-off spot may be any designated trailer parking location in staging area 130, any loading dock in unloading area 140, and any loading dock within loading area 150.

Manual and/or automated techniques are used to offload the cargo from trailer 106 and into warehouse 110. During unloading, tractor 104 may remain hitched to trailer 106 or may decouple (e.g., unhitch) to perform other tasks. After unloading, mission controller 102 directs tractor 104 to move trailer 106 from a pick-up spot in unloading area 140 and to a drop-off spot, either returning trailer 106 to staging area 130 or delivering trailer 106 to an assigned loading dock in a loading area 150 of warehouse 110, where trailer 106 is then loaded for example. Once loaded, mission controller 102 directs tractor 104 to move trailer 106 from a pick-up spot in loading area 150 to a drop-off spot in staging area 130 where it may await collection by another (or the same) OTR tractor 108. Given the pick-up spot and the drop-off spot, tractor 104 may autonomously move trailer 106.

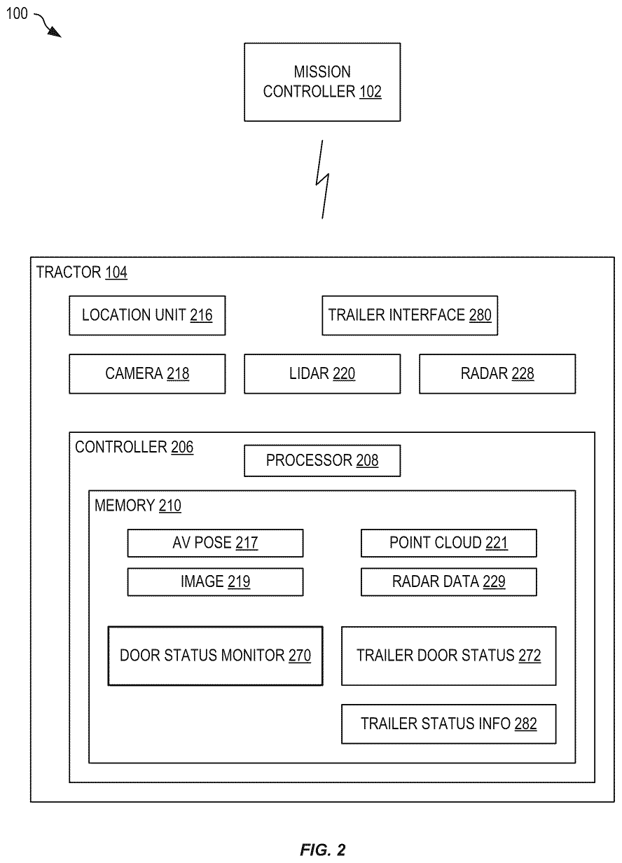

FIG. 2 is a block diagram illustrating functional components of tractor 104. Tractor 104 includes a controller 206 with at least one digital processor 208 communicatively coupled with memory 210 that may include one or both of volatile memory (e.g., RAM, SRAM, etc.) and non-volatile memory (e.g., PROM, FLASH, Magnetic, Optical, etc.). Memory 210 stores a plurality of software modules including machine-readable instructions that, when executed by the at least one processor 208, cause the at least one processor 208 to implement functionality of tractor 104 as described herein. In certain embodiments, tractor 104 operates autonomously within autonomous yard 100 under direction from mission controller 102.

Tractor 104 also includes a location unit 216 that determines an AV pose 217 (e.g., an absolute geographic location and orientation) of tractor 104, a plurality of cameras 218 for capturing images of objects around tractor 104, at least one Light Detection and Ranging (LIDAR) device 220 for determining a point cloud 221 of objects around tractor 104, and at least one radar 228 for generating radar data 229 of objects around tractor 104. In certain embodiments, at least one radar 228 is rear facing. Location unit 216, the plurality of cameras 218, radar 228, and the at least one LIDAR device 220, cooperate with controller 206 to enable autonomous maneuverability and safety of tractor 104.

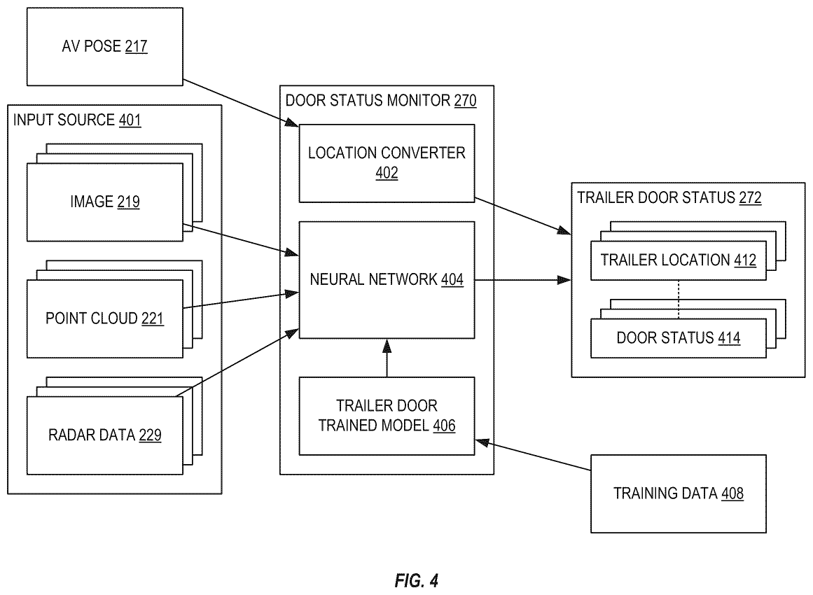

Tractor 104 also include a door status monitor 270, implemented as machine-readable instructions stored in memory 210 and executable by processor 208, that is activated to determine a trailer door status 272 that indicates one or more of a rear door status of a trailer hitched to tractor 104 and/or a location and rear door status of trailers around (e.g., within detection range of at least one of camera 218, LIDAR device 220, or radar 228) tractor 104. Functionality of door status monitor 270 is described below with reference to FIG. 4. Door status monitor 270 may represent, or be part of, a perception module that perceives other information (e.g., trailer angle, trailer length, etc.) of tractor 104 and/or trailer 106 based on multiple input sources (see input source 401, described below).

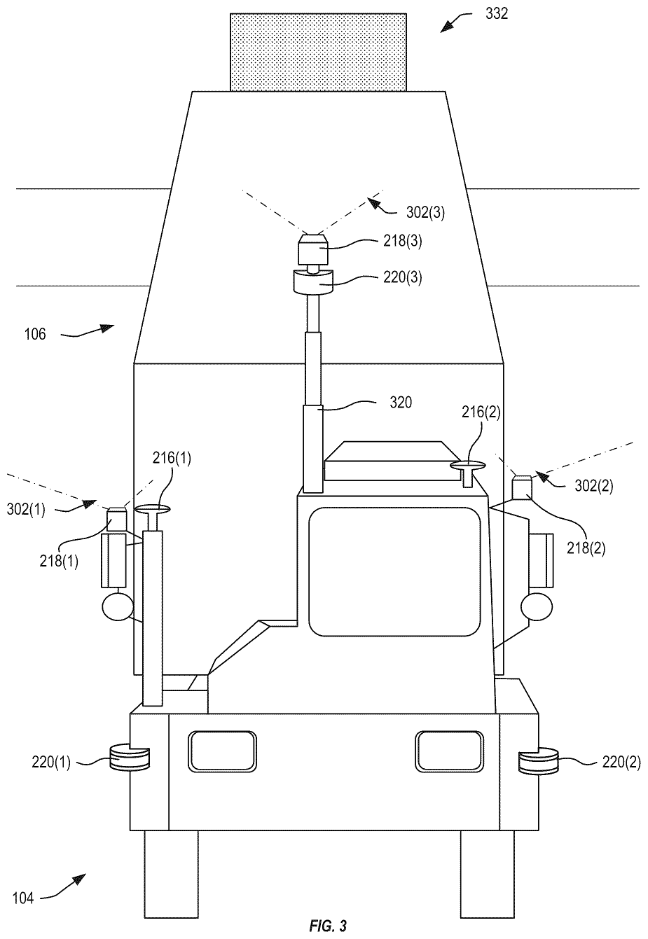

FIG. 3 is a schematic showing autonomous tractor 104 reversing trailer 106 up to a loading dock 332. In this example, tractor 104 uses multiple rear facing cameras 218 and/or LIDAR devices 220 to assist with maneuvering, however, trailer 106 obscures any view tractor 104 has of an area immediately behind trailer 106. Although, as described above, many different safety procedures (e.g., drive by) may be implemented, when reversing, any object that moves into the area behind trailer 106 is not detected by tractor 104.

As shown in FIG. 3, tractor 104 has two rear-facing cameras 218(1)-(2), one positioned at each side of tractor 104, near wing mirrors for example, such that each has a rearward field-of-view 302 that includes a corresponding side of trailer 106. As tractor 104 is reversing trailer 106 into loading dock 332, controller 206 evaluates images 219 captured by cameras 218, identifies any fiducial markings or other structures of loading dock 332 captured in the images, and computes a relative navigation solution for tractor 104 relative to loading dock 332 and its position within the images. That is, controller 206 may use images 219 to improve location and orientation estimates of tractor 104 and/or trailer 106, as compared to location and orientation determined by location unit 216 from an inertial navigation system and/or odometry where drift errors may occur, and from availability of GPS signals where discontinuities and canyon effect errors may occur. As shown in FIG. 3, tractor 104 may have two location units 216(1) and 216(2) positioned apart to facilitate determination of AV pose 217.

In certain embodiments, another camera 218(3) may be fitted to an extendable mast 320 coupled with tractor 104. As trailer 106 approaches loading dock 332, mast 320 may be extended to provide camera 218(3) with a higher vantage point thereby providing camera 218(3) with a field-of-view 302(3) over trailer 106. For example, where building structure, other adjacent trailers, etc. prevent cameras 218(1) and 218(2) from capturing useful images of loading dock 332, camera 218(3), positioned on extendable mast 320, may have an unobstructed view of loading dock 332, thereby allowing images 219 captured, at intervals or substantially continuously, by camera 218(3) may be used to provide a local frame of reference for tractor 104 that allows controller 206 to more accurately estimate a location and orientation of tractor 104 and trailer 106. Similarly, a LIDAR device 220(3) may be attached to mast 320, such that mast 320 provides LIDAR device 220(3) with a field-of-view 504(3) over trailer 106.

### Trailer Door Status Detection

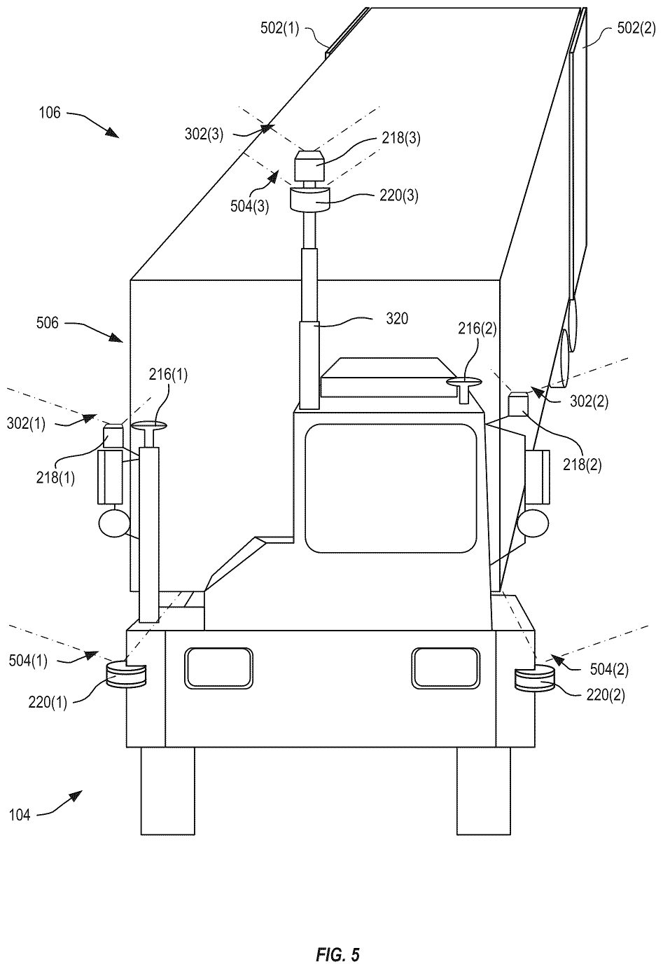

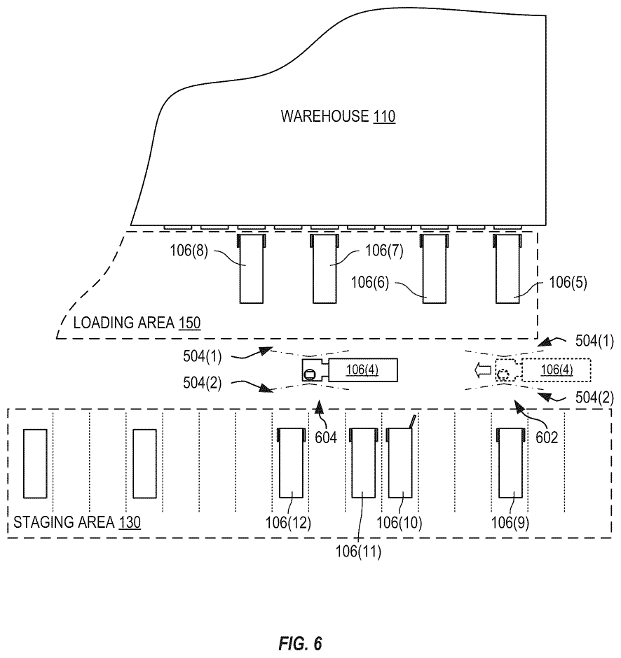

FIG. 4 is a block diagram illustrating door status monitor 270 of FIG. 2 in further example detail, in embodiments. FIG. 5 is a schematic diagram illustrating example use of camera 218(2), LIDAR device 220(2), and/or radar 228 by door status monitor 270 of FIG. 4 to determine trailer door status 272 of trailer 106 being towed by tractor 104, in embodiments. FIG. 6 is a schematic diagram illustrating example use of camera 218(2), LIDAR device 220(2), and/or radar 228 by door status monitor 270 of FIG. 4 to determine trailer door status 272 of other trailers encountered within autonomous yard 100. FIGS. 4, 5, and 6 are best viewed together with the following description.

Door status monitor 270 includes a neural network 404 that uses a trailer door trained model 406 to process an input source 401 that include one or more of images 219, point clouds 221, and radar data 229 to determine a trailer door status 272 that defines both (a) a trailer location 412 and (b) a corresponding door status 414. Input source 401 is captured by one or more of camera 218, LIDAR device 220, and radar 228 of tractor 104, where camera 218, LIDAR device 220, and radar 228 are configured in a fixed positional and orientational relationship with one another and with tractor 104. Trailer location 412 may define one or more of a distance of the door (e.g., rear door 502(1) or rear door 502(2)) and trailer 106 from tractor 104, a GPS global position of the door and/or the trailer, and a position of the door and/or the trailer on a previously-built environment map. Door status 414 may define one or more of open, close, and partially open.

Trailer door trained model 406 is generated for certain positions of cameras 218, LIDAR devices 220, and radar 228, where the position and orientation of each camera 218, LIDAR device 220, and radar 228 does not change relative to tractor 104. Accordingly, the field-of-view of each camera 218, LIDAR device 220, and radar 228 allows door status monitor 270 to determine trailer location 412 based on AV pose 217. As described below, neural network 404 is trained using a large amount of training data 408 that includes a multitude of trailers and trailer doors of different types, colors, wear conditions and status (open, close, partially-open, and so on).

In certain embodiments, door status monitor 270 determines trailer location 412 as a position relative to tractor 104, and a location converter 402 of door status monitor 270 converts trailer location 412 into a geographic location based on a current (e.g., most recently determined) AV pose 217. That is, location converter 402 converts each relative trailer position identified within 272 into a geographic location (e.g., latitude/longitude) that may, for example, be used to identify a parking spot occupied by the trailer.

For clarity of illustration, FIGS. 5 and 6 show two separate scenarios where FIG. 5 illustrates use of camera 218(2) to determine door status 414 of latched open rear door 502(2) of trailer 106 being towed by tractor 104 and FIG. 6 illustrates use of LIDAR devices 220 to detect trailer location 412 and door status 414 of trailer 106 around tractor 104. Advantageously, door status monitor 270 may process input source 401 to detect door status 414 of multiple trailers 106 simultaneously, where door status 414 indicates a status of each identified rear door.

In the example of FIG. 5, trailer 106 is at a slight angle relative to tractor 104 such that field-of-view 302(2) of camera 218(2) includes latched open rear door 502(2), but rear field-of-view 302(1) of camera 218(1) does not include latched open rear door 502(1), since it is blocked by front corner 506 of trailer 106. However, since latched open rear door 502(1) may be included in images 219 and/or point cloud 221 from camera 218(3) and LIDAR device 220(3), respectively, on extendable mast 320, door status monitor 270 may still detect door status 414 of latched open rear door 502(1). In embodiments where extendable mast 320 and camera 218(3) and LIDAR device 220(3) are not included, door status monitor 270 may detect door status 414 of latched open rear door 502(1) as tractor 104 makes a right turn when maneuvering trailer 106 through autonomous yard 100, causing latched open rear door 502(1) to become positioned within rear field-of-view 302(1) of camera 218(1) and/or within field-of-view 504(1) of LIDAR device 220(1).

In the example of FIG. 6, door status monitor 270 determines a status of rear doors of trailers 106 around tractor 104, such as trailers 106 positioned within autonomous yard 100. Camera field-of-views 302 and radar field-of-views are omitted from FIG. 6 for clarity of illustration, and LIDAR field-of-views 504(1) and 504(2) are shown relative to tractor 104 as it performs a task (e.g., moving trailer 106(4)) within autonomous yard 100. Tractor 104 is shown in dashed outline at a first location 602 and in solid outline at a second location 604, thereby representing movement of tractor 104 from first location 602 to second location 604 over time.

In certain embodiments, door status monitor 270 runs as a service that is activated and deactivated by controller 206. When active, door status monitor 270 may continuously, or at intervals, autonomously determines trailer door status 272 of both hitched trailer 104(4) (e.g., see FIG. 5) and near-by (FIG. 6) trailers 106(5)-(12) captured within images 219, point cloud 221, and radar data 229. For example, door status monitor 270 may receive images 219, point cloud 221, and radar data 229 substantially continuously from multiple cameras 218, LIDAR devices 220, and radars 228 configured with tractor 104, both when tractor 104 is stationary and while tractor 104 is moving. In one example, controller 206 activates door status monitor 270 in response to a mission plan received from mission controller 102 to determine trailer door status 272 of trailer 106 hitched to tractor 104 (a) prior to moving trailer 106 (e.g., after hitching but before moving trailer 106), (b) shortly after trailer 106 begins moving (e.g., during forward acceleration of trailer 106), (c) at turns in the path (e.g., as tractor 104 makes a first left turn and a first right turn), (d) when trailer 106 is decelerated (e.g., when tractor 104 is braking), (e) when tractor 104 transitions between forward and backwards movements, and (f) prior to reversing trailer 106 into a parking space or loading dock. Particularly, controller 206 may activate door status monitor 270 to determine door status 414 corresponding to hitched trailer 106 at times when the maneuvering of trailer 106 may cause unlatched doors to swing, and when an unlatch door status may cause problems, such as when reversing into a parking spot of staging area 130 or positioning trailer 106 at a loading dock (e.g., within loading area 150). In another example of operation, controller 206 activates door status monitor 270 to determine trailer door status 272 of trailers being passed as tractor 104 maneuvers within autonomous yard 100. Controller 206 sends trailer door status 272 to mission controller 102, which autonomously updates its stored status information on both trailer location 412 and corresponding door status 414. Advantageously, mission controller 102 receives trailer door status 272 continuously, or at intervals, as one or more tractors 104 move through autonomous yard 100, thereby maintaining a current status of trailer location and door status.

Using the example of FIG. 5, door status monitor 270 processes images 219 from cameras 218 to generate trailer door status 272 indicating door status 414 of trailer 106 being towed by tractor 104, where trailer location 412 indicates a current location of trailer 106 and whether trailer 106 is being towed by tractor 104. Door status monitor 270 generates trailer door status 272 relatively quickly such that any distance traveled by trailer 106 from the instant of capture of input source 401 is considered negligible, or may be taken into account when the data is used by other functions.

In another example of operation, as tractor 104 passes staging area 130, door status monitor 270 processes AV pose 217 and point cloud 221 to generate trailer door status 272 for one or more trailers 106(9)-(12) parked in staging area 130, where trailer door status 272 defines trailer location 412 and corresponding door status 414 for each detected trailer 106. Similarly, and concurrently in the example of FIG. 6, as tractor 104 passes loading area 150, door status monitor 270 processes AV pose 217 and radar data 229 to generate trailer door status 272 for one or more trailers 106 parked in loading area 150, where trailer door status 272 defines trailer location 412 and corresponding door status 414 for each detected trailer 106. For example, when tractor 104 and trailer 106(4) are at first location 602, LIDAR field-of-view 504(1) includes information of at least trailers 106(5) and 106(6), and LIDAR field-of-view 504(2) includes information of at least trailers 106(9) and 106(10). Accordingly, where input source 401 includes sufficient information, door status monitor 270 generates trailer door status 272 to include trailer location 412 and door status 414 for each of trailers 106(5), 106(6), 106(9), and 106(10). Since door status monitor 270 operates continuously or at frequent intervals, as tractor 104 moves other trailers 106 fall within LIDAR field-of-views 504 and door status monitor 270 determines respective trailer door status 272. For example, when tractor 104 and trailer 106(4) are at second location 604, LIDAR field-of-view 504(1) includes information of at least trailers 106(7) and 106(8), and LIDAR field-of-view 504(2) includes information of at least trailers 106(10). 106(11), and 106(12). Accordingly, where input source 401 includes sufficient information, as tractor 104 moves from first location 602 to second location 604 for example, door status monitor 270 generates trailer door status 272 to include trailer location 412 and door status 414 for each of trailers 106(7), 106(8), 106(10), 106(11), and 106(12).

### Trailer Door Status Detection Training

Neural network 404 uses trailer door trained model 406 that is generated by training neural network 404 using a large volume of training data 408 (e.g., a training set). Training data 408 includes images 219, point clouds 221, and radar data 229 collected from at least one capture device (e.g., tractor 104) operating in multiple yards and under various use cases (e.g., performing different tasks within different yards) and various environmental conditions (e.g., different weather conditions, different seasons, different times of the day, etc.), where trailers are parked, moving, or being towed with doors in various states including closed, open, latched, and so on. Training data 408 may define one or more of a distance of a captured trailer door and its trailer from the tractor capturing training data 408, a geographical location (e.g., GPS coordinates), and a previously-built environment map position. Training data 408 may also include 3D annotation of captured trailers and captured trailer doors and extensive human-annotated attributes including a door type (e.g. roll-on, latchet etc.), a door status (e.g., open, close, partially open, etc.). When possible, training data 408 may include accurate annotation in 3D of the captured door and a corresponding door frame. Particularly, training data 408 (e.g., images 219, point clouds 221, and radar data 229) is collected in weather conditions and at sites that are relevant to expected operation of trailer door status 272 (e.g., for a particular the business case). The capture devices (e.g., vehicles or tractors 104) are configured with cameras 218, LIDAR devices 220, and radars 228, at the same position and orientation relative to tractor 104 using door status monitor 270 such that the captured training data 408 is consistent with input source 401. For example, tractor 104 may be used to capture images 219, point clouds 221, and radar data 229 as it travels through autonomous yard 100, where the images, point clouds, and radar data are used to form training data 408.

Training data 408 (e.g., captured images 219, point clouds 221, and radar data 229) may be stored and then annotated to define a ground truth for operating neural network 404 to perform the desired task. In one example, annotations are added to training data 408 to indicate trailers and doors (e.g., in images 219, and in 3D within point clouds 221 and radar data 229) by humans interacting with a user interface that facilitates annotation. In another example, prior to capturing images 219, point clouds 221, and radar data 229, the trailers and trailer doors within the yard are marked using fiducial markers (e.g. adhesive stickers defining trailer and door conditions) or other forms of markings, that are recognized by a software algorithm that autonomously adds the annotations to training data 408. For example, the fiducial markers are attached to the trailer rear doors such they will be captured within training data 408 and recognized by the software algorithm which adds corresponding annotation to the training data 408. Training data 408 is then uses to train neural network 404 and generate trailer door trained model 406 for use during operation of door status monitor 270.

### Stand Alone Door Status Monitor

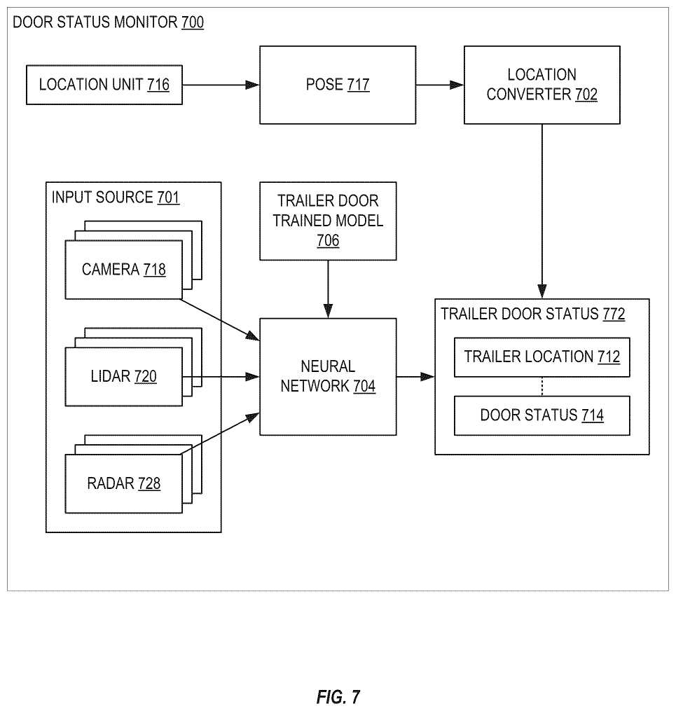

FIG. 7 is a block diagram illustrating one example stand-alone door status monitor 700, in embodiments. Stand-alone door status monitor 700 operates similar to trailer door status 272 of FIG. 4, does not use input from external sources, and thereby may operate independently on any vehicle or platform to determine trailer door status 772 (e.g., trailer location 712 and door status 714). Accordingly, stand-alone door status monitor 700 may be easily used in scenarios or locations other than autonomous yards, such as any of a harbor, an airport, with a storage system, and at intermodal freight transfer facilities.

Stand-alone door status monitor 700 includes a neural network 704 controlled by a trailer door trained model 706, a location unit 716, and one or more of: a camera 718, a LIDAR device 720, and a radar 728 that function as an input source 701 for neural network 704. Neural network 704 is similar to neural network 404 of FIG. 4. In on example, stand-alone door status monitor 700 is configured with two LIDAR devices 720. In another example, stand-alone door status monitor 700 is configured with one LIDAR device 720 and one camera 718. Location unit 716 may include a global navigation satellite system (GNSS) receiver that determines a current location of stand-alone door status monitor 700, and may also include one or more of a magnetic compass, gyroscope, and accelerometer, that determines a pose 717, defining orientation of stand-alone door status monitor 700, that allows a location converter 702 to convert a relative trailer location (e.g., relative to stand-alone door status monitor 700) into a geographic location (e.g., latitude/longitude).

Stand-alone door status monitor 700 has a single rigid body (e.g., a bar or a box that is mountable to a vehicle) that supports one or more of cameras 718, LIDAR devices 720, and radars 728 in a fixed positional and orientational relationship. The body may also support other components of stand-alone door status monitor 700. Trailer door trained model 706 is created using images, point clouds, and radar data captured by camera 718, LIDAR device 720, and radar 728 and then annotated as described above. For example, when multiple units are similarly constructed (e.g., similar positioning, orientation, and fixed relationship of camera 718, LIDAR device 720, and radar 728), any one or more of the units may be used to capture training data.

Stand-alone door status monitor 700 operates similar to door status monitor 270 described above and generates trailer door status 772 for external processing. For example, stand-alone door status monitor 700 may send trailer door status 772 to an external device (e.g., a cloud service, a computer server, etc.) for further processing. However, stand-alone door status monitor 700 uses one or more of camera 718, LIDAR device 720, and radar 728 instead of cameras 218, LIDAR devices 220, radars 228 of tractor 104 and determines pose 717 using location unit 716.

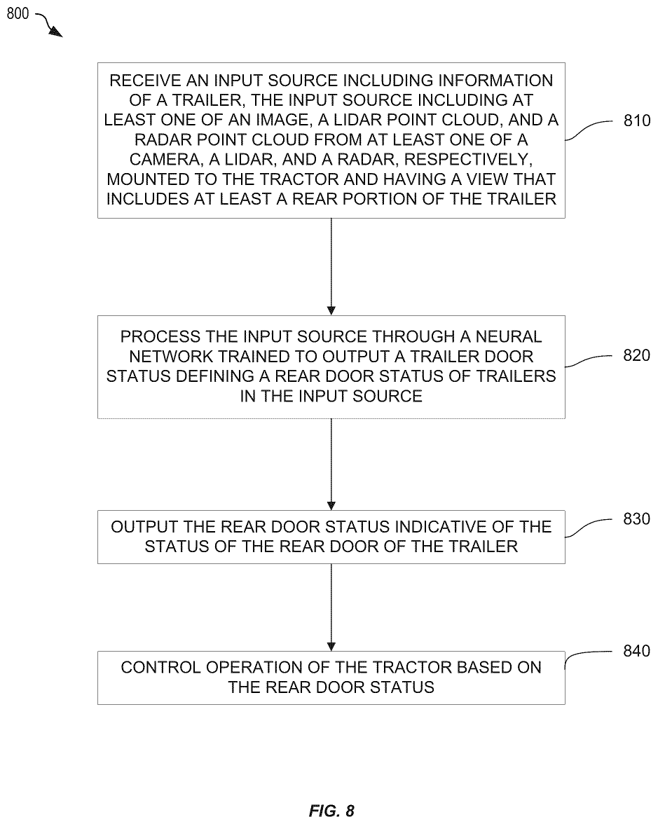

FIG. 8 is a flowchart illustrating one example method 800 for determining a status of a rear door of a trailer from a tractor, in embodiments. Method 800 is implemented by door status monitor 270 of FIG. 2 and/or stand-alone door status monitor 700 of FIG. 7, for example.

In block 810, method 800 receives an input source including information of the trailer, where the input source includes at least one of an image, a LIDAR point cloud, and a RADAR point cloud from at least one of a camera, a LIDAR, and a RADAR, respectively, mounted to the tractor and having a view that includes at least a rear portion of the trailer. In one example of block 810, door status monitor 270 receives input source 401 that include images 219 from camera 218(1), a point cloud 221 from LIDAR device 220(1), and radar data 229 from radar 228. In another example of block 810, stand-alone door status monitor 700 controls one or more of camera 718, LIDAR device 720, and radar 728 to capture input source 701.

In block 820, method 800 processes the input source through a neural network trained to output a trailer door status defining a rear door status of trailers in the input source. In one example of block 820, door status monitor 270 processes input source 401 through neural network 404 using trailer door trained model 406 to generate trailer door status 272 that includes trailer location 412 and door status 414 for each trailer with sufficient information within input source 401. In another example of block 820, stand-alone door status monitor 700 processes input source 701 through neural network 704 using trailer door trained model 706 to generate trailer door status 772 that includes trailer location 712 and door status 714.

In block 830, method 800 outputs the rear door status indicative of the status of the rear door of the trailer. In one example of block 830, door status monitor 270 outputs trailer door status 272 and controller 206 sends trailer door status 272 to mission controller 102, which autonomously updates its stored status information on both trailer location 412 and corresponding door status 414. In another example of block 830, stand-alone door status monitor 700 sends trailer door status 772 to an external device for further processing.

Block 840 is optional. When included, in block 840, method 800 controls operation of the tractor based on the rear door status. In one example of block 840, where door status 714 indicates that one of rear doors 502 is not latched open as tractor 104 maneuvers trailer 106 through autonomous yard 100, tractor 104 stops and/or inhibits further maneuvering of trailer 106 to allow the door to be latched. In another example of block 840, where door status 714 indicates that rear doors 502 are not latched open, tractor 104 inhibits reversing of trailer 106 into a loading dock within loading area 150. For example, tractor 104 may stop and generate a request for manual assistance to lath the rear doors prior to further movement. Method 800 then repeats until deactivated by controller 206.

### Trailer Door Status Indicators

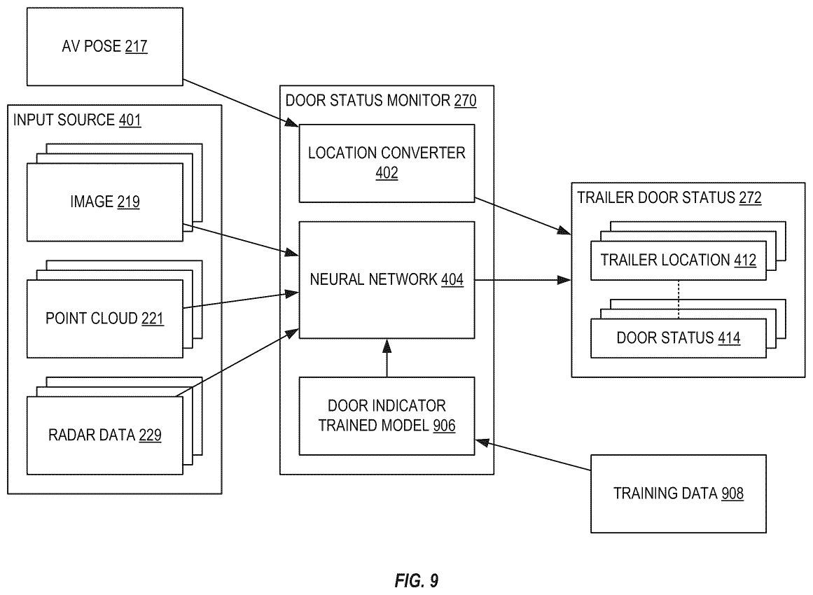

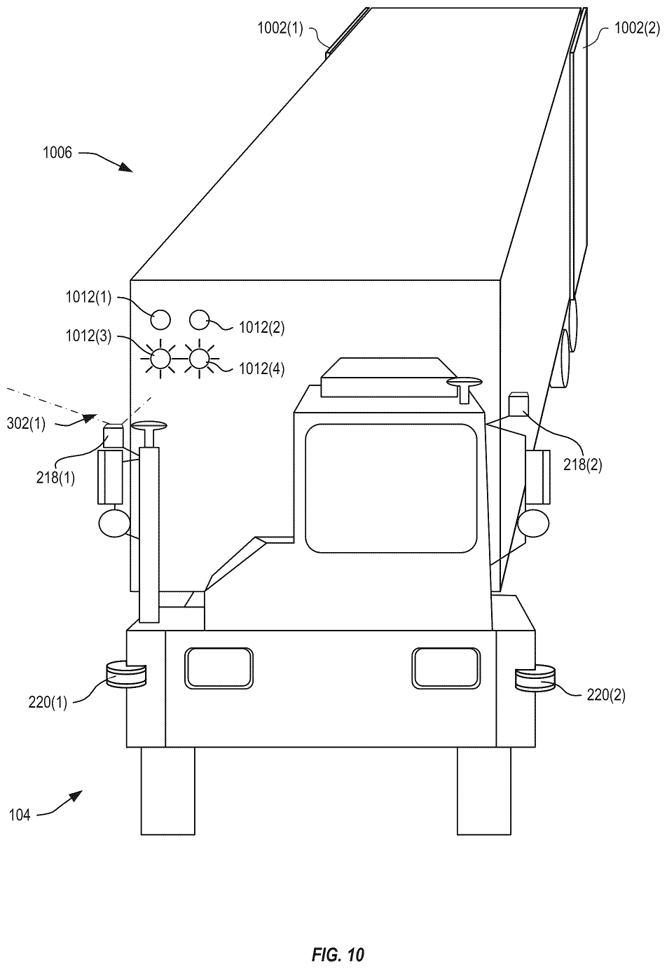

FIG. 9 is a block diagram illustrating door status monitor 270 of FIG. 2 in further example detail, in embodiments. FIG. 10 is a schematic diagram illustrating example use of camera 218(2) by door status monitor 270 of FIG. 9 to determine trailer door status 272 of a trailer 1006 being towed by tractor 104 that includes door-status indicators 1012, in embodiments.

Trailer 1006 may include at least one sensor (not shown) that detects a status of each rear door 1002(1) and 1002(2) and indicates the status on at least one door-status indicator 1012. In this example, trailer 1006 includes a first sensor that detects when rear door 1002(1) is latched closed, a second sensor that detects when rear door 1002(2) is latched closed, a third sensor that detects when rear door 1002(1) is latched open, and a fourth sensor that detects when rear door 1002(2) is latched open. Rear-door status indicator 1012(1), indicates rear door 1002(1) is latched closed, rear-door status indicator 1012(2) indicates rear door 1002(2) is latched closed, rear-door status indicator 1012(3) indicates rear door 1002(1) is latched open, and rear-door status indicator 1012(4) indicates rear door 1002(2) is latched open. In this example, door-status indicators 1012 illuminate to indicate the corresponding detected status. In the example shown, rear-door status indicator 1012(3) and 1012(4) are illuminated to indicate that both rear doors 1002(1) and 1002(2) are latched open. Where none of door-status indicators 1012 are illuminated, neither of trailer doors 1002(1) or 1002(2) are latched.

In this embodiment, neural network 404 uses a door indicator trained model 906 to process input source 401 to determine trailer door status 272 that defines both (a) trailer location 412 and (b) corresponding door status 414. Door indicator trained model 906 is generated for certain positions of cameras 218, LIDAR devices 220, and radar 228, where the position and orientation of each camera 218, LIDAR device 220, and radar 228 does not change relative to tractor 104. Accordingly, the field-of-view of each camera 218, LIDAR device 220, and radar 228 allows door status monitor 270 to determine trailer location 412 based on AV pose 217. As described above, neural network 404 is trained using a large amount of training data 908 that, in this embodiment, also includes a multitude of trailers with door-status indicators 1012 in various combinations of activation based on trailer doors of different types, colors, wear conditions and status (open, close, partially-open, and so on).

As described above, door status monitor 270 may determine trailer location 412 as a position relative to tractor 104 where location converter 402 of door status monitor 270 converts trailer location 412 into a geographic location based on current AV pose 217. In this example, training data 908 includes ground truths corresponding to the indicated status of door-status indicators 1012. In certain embodiments, training data 908 includes trailers that have door-status indicators 1012 and trailers that do not have door-status indicators 1012. Accordingly, door indicator trained model 906 is generated to allow neural network 404 to determine a status of trailer doors 1002 irrespective of whether the trailer includes door-status indicators 1012.

In certain embodiments, tractor 104 includes a trailer interface 280 (see FIG. 2) that receives trailer status information 282 from trailer 1006, where trailer 1006 is a smart trailer. Trailer interface 280 may implement wired and/or wireless communication with a corresponding interface of trailer 1006. For example, the wired communication may be implemented by one or more of an autonomous electrical connection and/or an electrical connection implemented through a fifth-wheel of tractor 104. See, for example, US patent application number US2023/0145675 A1, filed Nov. 9, 2022, titled “Autonomous trailer connectivity,” and incorporated herein by reference for enablement purposes. Trailer status information 282 may include at least one of a trailer door status (e.g., latched or unlatched status of open and/or closed rear doors of trailer 1006), a geographic location (e.g., determine by GPS receiver of trailer 1006), a dock door status (e.g., when trailer 1006 is positioned at a dock door), a loaded or unloaded status of trailer 1006, trailer damage information (e.g., collision logs), and tire pressure information.

### Combination of Features

Features described above as well as those claimed below may be combined in various ways without departing from the scope hereof. The following enumerated examples illustrate some possible, non-limiting combinations:

(A1) A method for determining a status of a rear door of a trailer from a tractor, including: receiving an input source including information of the trailer, the input source including at least one of an image, a LIDAR point cloud, and a RADAR point cloud from at least one of a camera, a LIDAR, and a RADAR, respectively, mounted to the tractor; processing the input source through a neural network using a trailer door trained model to generate a trailer door status defining the status of the rear door of the trailer; and outputting the trailer door status.

(A2) In embodiments of (A1), the trailer door trained model is trained to generate the trailer door status when the trailer is being towed by the tractor.

(A3) Either of embodiments (A1) or (A2), the trailer door trained model is trained to generate the trailer door status when the trailer is parked and the tractor is passing the trailer.

(A4) In any of embodiments (A1)-(A3), the trailer door status including a trailer location indicative of a location of the trailer, wherein the trailer location defines one of a relative location of the trailer with respect to the tractor and a geographic location of the trailer.

(A5) Any of embodiments (A1)-(A4) further including inhibiting operation of the tractor when the trailer door status indicates one or more of the rear doors of the trailer and not latched open or latched closed.

(A6) Any of embodiments (A1)-(A5) further including receiving a first geographic location and orientation of the tractor corresponding to capture of the input source; and converting the relative location into a second geographic location of the trailer based on and the first geographic location and the orientation.

(A7) Any of embodiments (A1)-(A6) further including collecting, by at least one capture device during various environmental conditions and for various use cases, training data including one or more of a plurality of images, a plurality of point clouds, and a plurality of radar data; adding annotations to the training data to define a ground truth; and training the neural network using the training data to generate the trailer door trained model.

(A8) In any of embodiments (A1)-(A7), the training data includes a view of a rear door of a trailer, the various use cases comprising parked trailers, moving trailers, and towed trailers, where rear doors of each of the parked trailers, the moving trailers, and the towed trailers are one of closed, open, latched open, and latched closed.

(A9) In any of embodiments (A1)-(A8), the further training data includes a view of a rear door of a trailer, the adding further comprise defining, within the annotations, one or more of a distance of the rear door to a capture device that captured the training data, a distance of the trailer to the capture device, a geographical location of the trailer, and a position of the trailer on a previously-built environment map.

(A10) In any of embodiments (A1)-(A9), the training data includes a view of a rear door of a trailer, the adding further comprises interacting with a human using a user interface to define, within the annotations, a location of each of the trailers and a corresponding status of the rear door of the trailer.

(A11) In any of embodiments (A1)-(A10), the interacting further comprising capturing 3D annotations of the trailer and the rear door.

(A12) In any of embodiments (A1)-(A11), the 3D annotations further defining a door frame of the rear door.

(A13) In any of embodiments (A1)-(A12), the interacting comprising capturing attributes including a door type, and a door status defining one of closed, open, latched open, and latched closed.

(A14) In any of embodiments (A1)-(A13), the training data includes a view of a rear door of a trailer, the adding comprising: recognizing, by an algorithm, fiducial markers in the training data; and annotating, by the algorithm, the training data based on the recognized fiducial marker, wherein the fiducial markers are positioned on at least one of the trailer and the rear door and define the status of the rear door.

(A15) In any of embodiments (A1)-(A14), the training data includes a front face of the trailer, the adding comprising interacting with a human using a user interface to define, within the annotations, a location of a door-status indicator on the front face of the trailer and a status of the rear door.

(B1) A method for determining a status of a rear door of a smart trailer from a tractor, including: receiving, by a controller of the tractor and from the smart trailer, a signal encoding trailer status information of the smart trailer; decoding, by the controller, the trailer status information to determine a status of a rear door of the smart trailer; and outputting, from the tractor, the trailer door status.

(B2) In the embodiment (B1), the status information indicates one of: the rear door is latched closed and the rear door is latched open.

(B3) In either of embodiments (B1) or (B2), the signal is received over a wired connection between the smart trailer and the tractor via one or both of a fifth-wheel and an autonomous electrical connection.

(B4) In any of embodiments (B1)-(B3), the signal is received wirelessly.

(C1) A door status monitor, including: a rigid body for attaching to a vehicle; at least one of a camera, a LIDAR, and a RADAR having fixed positional and orientational relationship by the rigid body; a neural network having a trailer door trained model that processes an input source including at least one of an image, a point cloud, and RADAR data captured by at least one of the camera, the LIDAR, and the RADAR to generate a trailer door status defining the status of a rear door of a trailer included in the input source; and outputting the trailer door status to an external device.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for determining a status of a rear door of a trailer from a tractor, comprising:
receiving an input source including information of the trailer, the input source including at least one of an image, a LIDAR point cloud, and a RADAR point cloud from at least one of a camera, a LIDAR, and a RADAR, respectively, mounted to the tractor;
processing the input source through a neural network using a trailer door trained model to generate a trailer door status defining the status of the rear door of the trailer; and
outputting the trailer door status.

2. The method of claim 1, wherein the trailer door trained model is trained to generate the trailer door status when the trailer is being towed by the tractor.

3. The method of claim 1, wherein the trailer door trained model is trained to generate the trailer door status when the trailer is parked and the tractor is passing the trailer.

4. The method of claim 1, the trailer door status including a trailer location indicative of a location of the trailer, wherein the trailer location defines one of a relative location of the trailer with respect to the tractor and a geographic location of the trailer.

5. The method of claim 4, further comprising inhibiting operation of the tractor when the trailer door status indicates one or more of the rear doors of the trailer and not latched open or latched closed.

6. The method of claim 5, further comprising:
receiving a first geographic location and orientation of the tractor corresponding to capture of the input source; and
converting the relative location into a second geographic location of the trailer based on and the first geographic location and the orientation.

7. The method of claim 1, further comprising:
collecting, by at least one capture device during various environmental conditions and for various use cases, training data including one or more of a plurality of images, a plurality of point clouds, and a plurality of radar data;
adding annotations to the training data to define a ground truth; and
training the neural network using the training data to generate the trailer door trained model.

8. The method of claim 7, where the training data includes a view of a rear door of a trailer, the various use cases comprising parked trailers, moving trailers, and towed trailers, where rear doors of each of the parked trailers, the moving trailers, and the towed trailers are one of closed, open, latched open, and latched closed.

9. The method of claim 7, where the training data includes a view of a rear door of a trailer, the adding further comprise defining, within the annotations, one or more of a distance of the rear door to a capture device that captured the training data, a distance of the trailer to the capture device, a geographical location of the trailer, and a position of the trailer on a previously-built environment map.

10. The method of claim 7, where the training data includes a view of a rear door of a trailer, the adding further comprises interacting with a human using a user interface to define, within the annotations, a location of each of the trailers and a corresponding status of the rear door of the trailer.

11. The method of claim 10, the interacting further comprising capturing 3D annotations of the trailer and the rear door.

12. The method of claim 11, the 3D annotations further defining a door frame of the rear door.

13. The method of claim 10, the interacting comprising capturing attributes including a door type, and a door status defining one of closed, open, latched open, and latched closed.

14. The method of claim 7, where the training data includes a view of a rear door of a trailer, the adding comprising:
recognizing, by an algorithm, fiducial markers in the training data; and
annotating, by the algorithm, the training data based on the recognized fiducial marker, wherein the fiducial markers are positioned on at least one of the trailer and the rear door and define the status of the rear door.

15. The method of claim 7, where the training data includes a front face of the trailer, the adding comprising interacting with a human using a user interface to define, within the annotations, a location of a door-status indicator on the front face of the trailer and a status of the rear door.

16. A method for determining a status of a rear door of a smart trailer from a tractor, comprising:
receiving, by a controller of the tractor and from the smart trailer, a signal encoding trailer status information of the smart trailer;
decoding, by the controller, the trailer status information to determine a status of a rear door of the smart trailer; and
outputting, from the tractor, the trailer door status.

17. The method of claim 16, wherein the status information indicates one of: the rear door is latched closed and the rear door is latched open.

18. The method of claim 16, wherein the signal is received over a wired connection between the smart trailer and the tractor via one or both of a fifth-wheel and an autonomous electrical connection.

19. The method of claim 16, wherein the signal is received wirelessly.

20. A door status monitor, comprising:
a rigid body for attaching to a vehicle;
at least one of a camera, a LIDAR, and a RADAR having fixed positional and orientational relationship by the rigid body;
a neural network having a trailer door trained model that processes an input source including at least one of an image, a point cloud, and RADAR data captured by at least one of the camera, the LIDAR, and the RADAR to generate a trailer door status defining the status of a rear door of a trailer included in the input source; and
outputting the trailer door status to an external device.
